(19) United States
(12) Patent Application Publication
(10) Pub. No.: US 2016/0358466 A1
(43) Pub. Date: Dec. 8, 2016

(54) Advance Warning System

(71) Applicant: Gary W. Youngblood, Birmingham, AL (US)

(72) Inventor: Gary W. Youngblood, Birmingham, AL (US)

(21) Appl. No.: 14/544,189

(22) Filed: Dec. 8, 2014

(51) Int. Cl. G08G 1/0965; H04L 29/08; H04W 4/22

(52) U.S. Cl. CPC G08G 1/0965; H04W 4/22; H04L 67/12

(57) ABSTRACT

The Advance Warning System™ is designd and intended as Emergency/Critical situation vehicle to vehicle ECV2V communications to notify driver that an ambulance is approaching from rear, a State Tropper has initiated a traffic stop ahead, which will enable driver to comply with move over laws in a controlled safe manner instead of creating a bottleneck in traffic due to a last minute realization of need to move over, or that a school bus is loading or unloading children just over the crest of a hill.

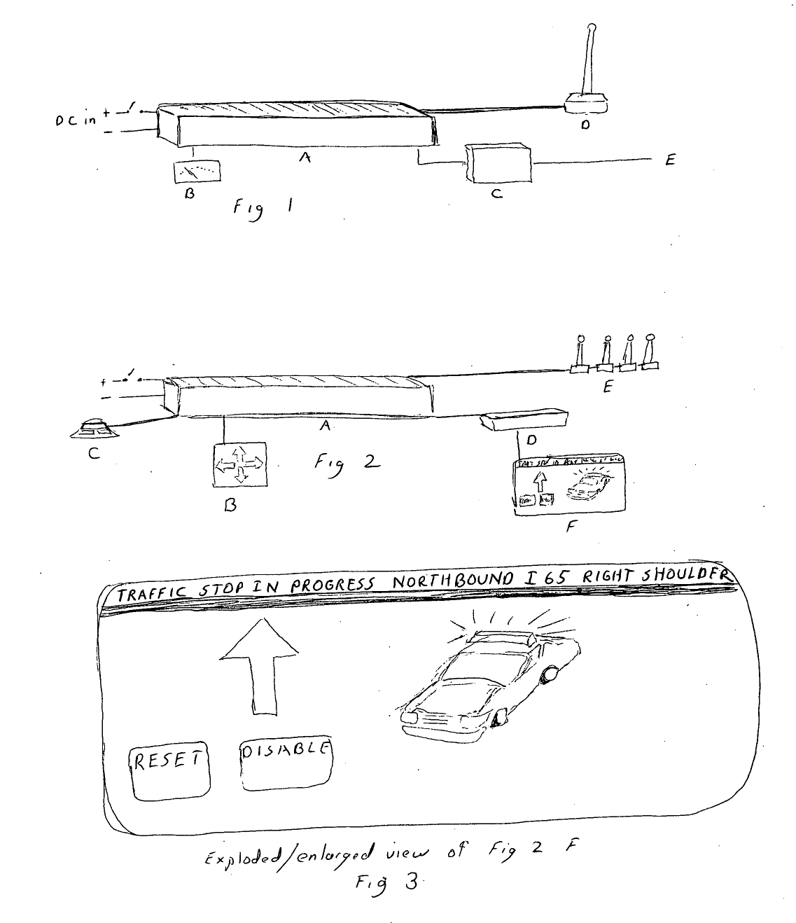

It can also be used to broadcast a brief emergency broadcast message to vehicles in the vicinity to warn of accident or other critical situation and suggest drivers seek an alternate route or other suggestion. These are but a few of the numerous instances where Advance Warning System™ can save time, money, and lives.

### CROSS REFERENCE TO RELATED APPLICATIONS

Provisional Application No. 62/125,184 Filing Date: Oct. 31, 2014

### STATEMENT REGARDING FEDERALLY SPONSORED RESEARCH AND DEVELOPMENT

Not Applicable

### BACKGROUND OF THE INVENTION

Advance Warning System will transmit a RF signal from emergency/critical situation vehicles to vehicles in the vicinity to warn of presence and/or approach of the emergency/critial situation vehicle—the appoximate direction of presence or approach—and/or a brief emergency broadcast message from First Responders on the scene of accident or other critical situation.

New vehicle noise cancellation systems and advanced soundproofing technologies have diminished the ability of hearing sirens. Vehicle to Vehicle and Vehicle to Infastructure systems currently in development are focused on immediate, near vicinity V2V communications for crash avoidance using DSRC* in a two way communication format, broadcasting each vehicles GPS coordinates, speed, heading and other data between V2V equipped vehicles, along with security certificates from a security management system, and central network server.

### *Dedicated Short Range Communications

Advance Warning System is intended as Emergency/Critical vehicle to Vehicle communication (ECV2V) using a more powerful, longer range RF broadcast in a one way communication format from emergency/critical situation vehicles to vehicles in the vicinity, (approximately 6 blocks), on a frequency allocated by the FCC for public safety to provide motorist with advance warning that a: First Responder vehicle is present or approaching, A school bus is stopped loading or unloading children, A tow truck or service vehicle is present or approaching, A train is approaching, ect., or warn of another type of critical situation via a brief emergency broadcast message directly from the First Responder on the scene of emergency to vehicles in the vicinity. Too many tradgedies occurr annually due to lack of warning of the presence and/or approach of emergency/critical situation vehicles.

### BRIEF SUMMARY OF THE INVENTION

Advance Warning System is designed and intended to be an upgrade to the audio/visual alert capabilities such as flashing lights, horn, siren, ect. that First Responder vehicles—Police, Fire, Medic, and critical situation vehicles—school bus while loading or unloading children, tow truck, road work vehicle, ect., and trains are limited to.

Transmitters on these vehicles (but not limited to), will broadcast a oneway RF signal out to a range of approximately 6 blocks on a frequency allocated by the FCC for public safety of life and property, upon the vehicle, (or other device) activating its alert.

Vehicles in the vicinity that are equipped with compatible receivers will mute the vehicles sound system, activate audio alert, and illuminate icons on the vehicles dashboard, infotainment system or other applicable video screen detailing the relative type of emergency/critical situation vehicle, a directional icon to inform direction of presence and/or approach, and/or a brief emergency broadcast message from First Responder or warning device on the scene of the situation.

Advance warning system is designed and intended to operate in the same capacity as a vehicles dashboard warning light—instant recognition of a critical siuation with minimal driver distraction.

currently proposed V2V sysyems are years away from being emplemented on a scale sufficient to address this critical need to upgrade the century old flashing light and siren alert capabilities that emergency/critical situation vehicles are limited to. Also, the potential of enabling access to emergency/critical situation vehicles GPS coordinates and critical operating systems—which are major concerns for the agencies and entities that own and operate emergency/critical situation vehicles, are not applicable to Advance Warning System™ ECV2V, as they are to currently proposed V2V systems.

### BRIEF DESCRIPTION OF THE SEVERAL VIEWS OF THE DRAWINGS

The submitted drawings detail the digital radio transmitters and receivers—Dedicated Short Range Communications (DSRC), vehicle onboard infotainment and/or other video screen. Examples of possible icons for illustration only as icons may vary, and examples of interfacing with vehicle electronics.

### DETAILED DESCRIPTION OF THE INVENTION

The Advance Warning Systems will transmit a unique dedicated RF signal broadcast from an emergency/critical situation vehicle to vehicles in the vicinity that are equipped with compatible receivers, to warn of presence and/or approach of emergency/critical situation vehicle, approximate direction of presence and/or approach, and/or a brief emergency broadcast message directly from designated First Responder or applicable warning device on the scene of emergency or critical situation.

Advance Warning System is comprised of solid state digital radio units, labeled by the National Highway Traffic Safety Administration and others as Dedicated short Range Communications (DSRC). Those DSRC units will be installed in emergency/critical situation vehicles and integrated into the vehicles electronics.

When the emergency or critical situation vehicle activates its flashing lights or other applicable alert, the Advance Warning Signal will be transmitted out to a range of approximately 6 blocks on a frequency allocated by the FCC for higher power, longer range than the frequency used for V2V.

The DSRC units on passenger and commercial vehicles will not have the ability to transmit the Advance warning System RF signal. These vehicles will be limited to only receiving the Advance Warning, as this will be a signal transmission unique to emergency/critical situation vehicles and devices only, on a frequency allocated for such public safety service.

The DSRC receiver units will be intergrated into a new vehicle electronics system to enable muting of sound system, and displaying of audio and visual alerts on the vehicles driver—vehicle interfaces such as, but not limited to, the vehicles sound system, audio chime, infotainment system or other compatible video screen.

After market, retrofit, and stand alone units will be available for existing and vintage vehicles for both Emergency/critical situation vehicles and all other vehicles, in addition to the OEM units for auto manufacturers.

The DSRC units, video screens, and vehicle electronics already exist, however these components are what are aecessary to produce the Advance Warning System™. It is the process—method, & result of sending emergency/critical situation vehicle public address, flashing light, siren, horn, or other applicable alert ability over a RF signal to be received and relayed to the driver via driver/vehicle interfaces that the Inventor is seeking patent on.

Advance Warning System™ can be designed to be interoperable with currently proposed vehicle to vehicle crash avoidance technology, or as a stand alone ad hoc network between emergency/critical situation vehicles and vehicles in the vicinity.

The radio frequency (RF) signal transmitted from Advance Warning System™ compatible transmitter onboard First Responder vehicle—Police, Fire, Medical, will radiate out to an area up to 6 blocks upon activation by the First Responder turning on flashing light, other alert, or the transmitter itself. The receivers, onboard vehicles in the vicinity that are equipped with Advance Warning System compatible receivers, will interface with the vehicles onboard electronics to mute the sound system, activate audio alert, and display informational icons on the vehicles infotainment or other compatible video screen including, but not limited to, simulation of a First Responder vehicle and/or its flashing lights, a directional arrow icon detailing approximate direction of presence and/or approach, and applicable text.

The radio frequency (RF) signal transmitted from Advance Warning System™ compatible transmitter onboard school bus will radiate out to an area up to 6 blocks upon activation by the school bus driver turning on their flashing light and deploying stop sign. The receivers onboard vehicles in the vicinity that are equipped with Advance Warning System™ compatible receivers, will interface with the vehicles onboard electronics to mute the sound system, activate audio alert, and display informational icons on the vehicles infotainment or other compatible video screen including, but not limited to, a simulation of stopped school bus and/or it's flashing lights and stop sign, a directional arrow icon detailing approximate direction of presence and/or approach, and applicable text.

The radio frequency (RF) signal transmitted from Advance Warning System™ compatible transmitter onboard service vehicle—tow truck, road work vehicle, snow plow, ect., will radiate out to an area up to 6 blocks upon activation by the operator turning on their flashing light or the transmitter itself. The receivers onboard vehicles in the vicinity that are equipped with Advance Warning System™ compatible receivers, will interface with the vehicles onboard electronics to mute the sound system, activate audio alert, and display informational icons on the vehicles infotainment or other compatible video screen including, but not limited to, a simulation of a service vehicle and/or its flashing lights, a directional arrow icon detailing approximate direction of presence and/or approach, and applicable text.

The radio frequency (RF) signal transmitted from Advance Warning System™ compatible transmitter onboard Train will radiate out to an area up to 6 blocks upon activation by the operator sounding trains horn or turning on the transmitter itself. The receivers onboard vehicles in vicinity that are equipped with Advance warning System™ compatible receivers, will interface with the vehicles onboard electronics to mute the sound system, activate audio alert, and display informational icons on the vehicles infotainment or other compatible video screen including, but not limited to, simulation of a train, rail crossing lights, ect. a directional arrow icon detailing the approximate direction of presence and/or approach, and applicable text.

1. The radio frequency (RF) signal transmitted from, but not limited to, designated First Responder vehicle will radiate out to an area up to 6 blocks upon activation by applicable designated operator. The receivers onboard vehicles in the vicinity that are equipped with Advance Warning System™ compatible receivers will interface with the vehicles onboard electronics to mute the sound system, activate audio alert and display informational icons and/or text on the vehicles infotainment screen or other compatible video screen including, but not limited to, a brief emergency broadcast message directly from the First Responder vehicle or other applicable warning device on the scene of the emergency or critical situation.
